(19) United States
(12) Patent Application Publication
(10) Pub. No.: US 2003/0200835 A1
(43) Pub. Date: Oct. 30, 2003

(54) Diffusion-brazing filler powder for parts made of an alloy based on nickel, cobalt or iron

(75) Inventors: Andre Malie, Chatellerault (FR); Pascal Etuve, Dissay (FR); Christian Michel, Chatellerault (FR); Frederic Jacquot, Chatellerault (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SNECMA SERVICES, Paris (FR)

(21) Appl. No.: 10/411,227

(22) Filed: Apr. 11, 2003

Related U.S. Application Data
(63) Continuation of application No. 10/112,719, filed on Apr. 2, 2002, now abandoned.

(51) Int. Cl. B23K 35/32

(52) U.S. Cl. 75/254

(57) ABSTRACT

A diffusion-brazing filler powder for a part made of a nickel-, cobalt- or iron-based alloy A comprising particles of a defined alloy material B having specific functional properties tailored to the area of application of said part. The particles are substantially spherical and carry, on their surfaces, in the form of incrustations, add-ons comprising at least one fluxing element taken from the group: boron and silicon, these encrusted add-ons also being present in a free state in said powder.

### BACKGROUND OF INVENTION

1. Field of the Invention

The present invention relates to a diffusion-brazing filler powder for parts made of an alloy based on nickel, cobalt or iron, having a polycrystalline or single-crystal structure, especially in the aeronautical field. It also relates to a compact fill-in obtained from said powder.

2. Summary of the Prior Art

The severe operating conditions imposed, for example, on industrial turbine and turbomachine blades, requiring especially excellent hot oxidation resistance and/or excellent corrosion resistance, these being combined with good high-temperature mechanical properties such as good creep resistance, have led to the use of superalloys based on nickel, cobalt or iron in order to manufacture them. To produce assemblies or overlay repairs, the standard fusion welding techniques prove to be ill-suited to these materials or would require complex processing operations often impossible to carry out.

In some applications, and especially for the repair of parts in the aeronautical field, fillers have also been produced using alloys of the MCrAlY type containing Cr, Al and Y, M denoting Ni, Co or Fe.

Diffusing-brazing processes have therefore been used. These processes, by not profoundly modifying the metallurgical structure of the material, aim to obtain homogeneous bonding from the chemical standpoint and also from the structural standpoint. An illustration of this is given, for example, by EP-A-0 075 497.

To make overlay repairs, it is known to use so-called two-component brazing powders consisting of a blend of two powders which are obtained especially by atomization in argon:

a superalloy powder of chemical composition close to that of the material to be repaired;

a powder based on nickel or cobalt containing 2 to 6% by weight of fluxing elements such as boron or silicon.

The diffusion-brazing operation is carried out at a temperature of between 1 050° C. and 1 220° C., selected to be below the melting point of the superalloy. At the temperature of the operation, the superalloy powder remains in the solid state and the powder containing the fluxing elements becomes liquid, ensuring both fluidity of the blend and the brazing of the superalloy powder particles to one another, resulting in densification and, by diffusion of the fluxing elements, isothermal solidification of the liquid joint at the brazing temperature. Interdiffusion between the brazed joint and the superalloy of the base metal ensures that the chemical compositions are made homogeneous. After conventional heat treatments, regions overlaid by diffusion-brazing possess the desired high-temperature mechanical properties, these being very close to those of the base material of the parts. Furthermore, coatings known for improving the high-temperature oxidation and corrosion resistance may be applied.

However, the known diffusion-brazing processes using two-component powders entail certain processing constraints and drawbacks:

the operation of blending the two powders is lengthy and irksome;

the operation of making the chemical composition of the blend homogeneous is difficult and requires many checks to be made, but the operation remains essential;

particular storage conditions must be provided in order to avoid any segregation of the blend; and

the ratio of the proportions of the two powders in the blend must furthermore be tailored according to the nature of the overlay and, in particular, the width of the cracks to be repaired.

### SUMMARY OF THE INVENTION

One of the objects of the invention is to obtain a filler powder which does not have the abovementioned drawbacks and can be used especially for implementing the diffusion-brazing processes of the type recalled above.

According to the invention, there is provided a diffusion-brazing filler powder for a part made of a nickel-, cobalt- or iron-based alloy A comprising particles of a defined alloy material B having specific functional properties tailored to the area of application of said part, said particles being substantially spherical and carrying, on their surfaces, in the form of incrustations, additions whose composition contains at least one fluxing element selected from the group consisting of: boron and silicon, the material of these encrusted additions also being present in the free state in the powder.

Said filler powder may especially be subjected to a sintering heat treatment cycle under specified conditions of rate of temperature rise, temperature and hold time, resulting in, a microstructure having a homogeneous distribution of fine pores, eutectic phases which are few in number, small in size and non-clustering, and a fine dispersion of hardening phases based on one or more fluxing elements, thereby obtaining a compact fill-in for a part made of a nickel-, cobalt- or iron-based superalloy A.

### BRIEF DESCRIPTION OF THE DRAWINGS

FIG. 1 shows a ×3500 micrograph obtained in a scanning electron microscope of a specimen of diffusion-brazing filler powder according to the invention; and

FIG. 2 shows a micrograph illustrating an example of a microstructure of a compact fill-in obtained using the filler powder according to the invention.

### DESCRIPTION OF THE PREFERRED EMBODIMENTS

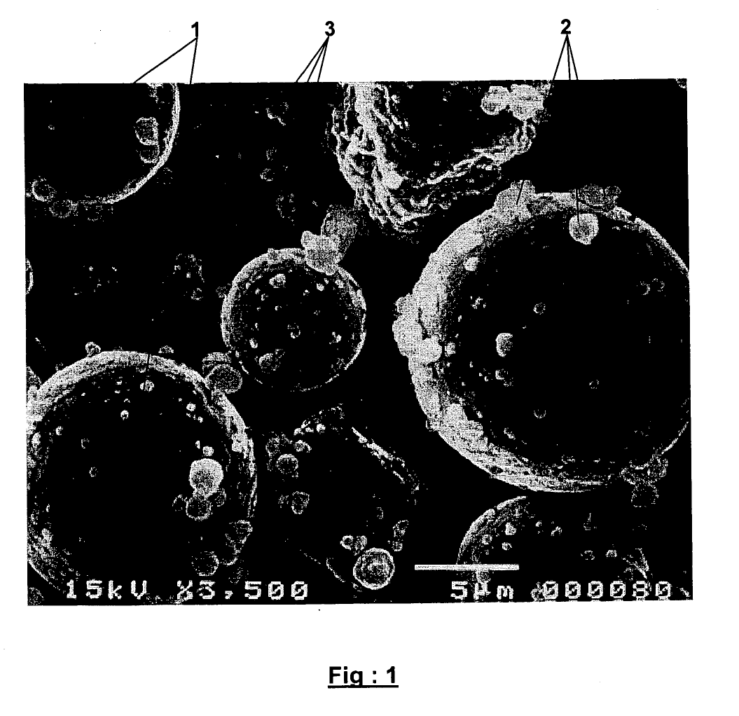

The constitution of a brazing filler powder according to the invention may be seen in the micrograph shown in FIG. 1. The particles 1 are composed of an alloy A, which may, for example, be nickel-based. Encrusted additions 2 on the surface of the particles 1 are composed of an alloy based on at least one fluxing element, such as boron or silicon. Small particles 3 in the free state between the alloy particles 1 are also formed from said alloy of one or more fluxing elements.

The powder thus formed is obtained by means of a mechanical synthesis technique known per se, by placing a powder blend consisting, on the one hand, of alloy B and, on the other hand, of an alloy of one or more fluxing elements in a container in a ball mill of any known, planetary, horizontal or vibratory, type.

The filler powder thus obtained can be used to implement any diffusion-brazing process applied in the manufacture or repair of parts made of a nickel-, cobalt- or iron-based alloy, especially in the aeronautical field. This may involve the joining of parts, the filling-in of crazes or cracks on a part, or the surface-overlaying of a part for the purpose of restoring the geometrical dimensions of the part.

The filler powder may be applied in various ways depending on the application. Thus, the powder may be used directly with the addition of an additive, especially a binder product of known type. The powder may also be used after it has been produced in tape form.

Remarkably, according to the invention, in some applications and especially in the case of surface-overlaying of a part, a filler may be made in the form of a compact fill-in.

Said compact fill-in is obtained from the powder by using manufacturing techniques known per se, especially by a means of compaction by sintering heat treatment cycle.

In particular, a compact fill-in may be obtained by holding at a temperature of between 1 160° C. and 1 200° C. for 5 minutes to one hour. The part obtained has a pore content of less than 4%.

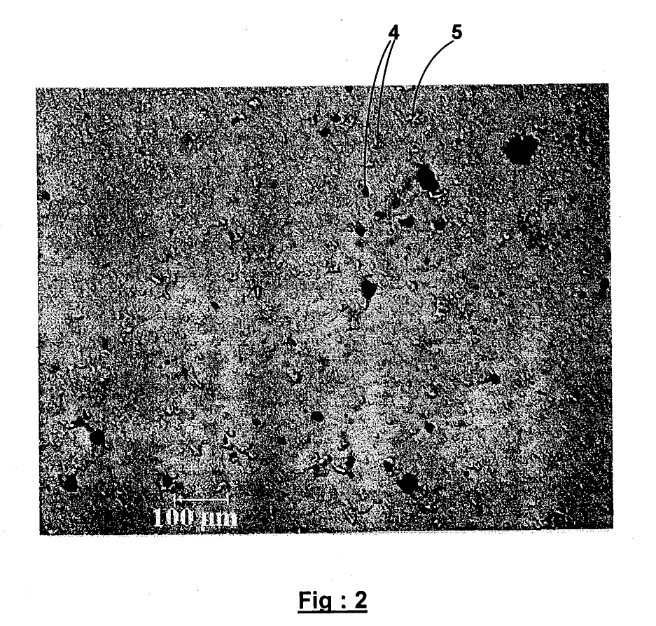

FIG. 2 shows an example of the result obtained. This result is remarkable by dint of its microstructure, which has an especially homogeneous distribution of fine pores 4 and of hardening phases 5 based on a fluxing element, especially borides or suicides, these being dispersed finely and in a controlled amount. It should also be noted that there is no eutectic phase.

All the uses of the filler powder according to the invention, whether for joining or repairing or overlaying, and whatever the form of application—direct application by adding a binder or, after intermediate processing, in the form of a tape or of a compact fill-in—have demonstrated a marked improvement in the service behavior of parts made of a nickel-, cobalt- or iron-based alloy.

The microstructures observed in the diffusion-brazed filled or bonded areas on the parts show remarkable characteristics obtained from the filler powder according to the invention.

In particular, the near absence of pores should be noted, but when they do exist they are small in size, homogeneously distributed and non-clustering. This results in the parts having good fatigue resistance behavior by eliminating or reducing fracture-initiating sites.

Likewise, the paucity of eutectic phases, which are small in size and non-clustering, improves the high-temperature behavior of the parts.

Furthermore, a homogeneous and fine distribution of the hardening phases based on one or more fluxing elements, such as borides or suicides, prevents the movement of dislocations and improves the fatigue resistance by delaying the appearance of cracks.

All these conditions are conducive to the parts resisting degradation in a severe environment, especially for aeronautical uses, at high temperatures and under oxidation/corrosion conditions, and when high mechanical strength characteristics are also desired.

We claim:

1. A diffusion-brazing filler powder for a part made of a nickel-, cobalt- or iron-based alloy A, said powder comprising particles of a defined alloy material B having specific functional properties tailored to the area of application of said part, said particles being substantially spherical and carrying, on their surfaces, in the form of incrustations, additions comprising at least one fluxing element selected from the group consisting of: boron and silicon, the material of said encrusted additions also being present in a free state in said powder.

2. The diffusion-brazing filler powder as claimed in claim 1, wherein the alloy B is identical to the alloy A.

3. The diffusion-brazing filler powder as claimed in claim 1, wherein the alloy B is of the MCrAlY type comprising Cr, Al and Y, and M denoting Ni, Co or Fe.

4. A compact fill-in for a part made of a nickel-, cobalt- or iron-based superalloy A, obtained by subjecting a filler powder as claimed in claim 1 to a sintering heat treatment cycle under specified conditions of rate of temperature rise, temperature and hold time, wherein the microstructure has a homogeneous distribution of fine pores and a fine dispersion of hardening phases based on one or more fluxing elements, and does not have a eutectic phase.
